(19) United States
(12) Patent Application Publication
(10) Pub. No.: US 2018/0034352 A1
(43) Pub. Date: Feb. 1, 2018

(54) DISC ROTOR- AND AXIAL FLUX-TYPE ROTATING ELECTRIC MACHINE

(71) Applicant: Olaf BÖTTCHER, Kamenz (DE)

(72) Inventor: Olaf BOETTCHER, Kamenz (DE)

(21) Appl. No.: 15/553,679

(22) PCT Filed: Feb. 25, 2016
(86) PCT No.: PCT/DE2016/100082

§ 371 Date: Aug. 25, 2017

(30) Foreign Application Priority Data
Feb. 26, 2015 (DE) 10 2015 102 804.2

(51) Int. Cl. H02K 16/00; H02K 3/28; H02K 1/27; H02K 3/18; H02K 1/14; H02K 1/18

(52) U.S. Cl. CPC H02K 16/00; H02K 1/14; H02K 1/182; H02K 1/2793; H02K 3/18; H02K 3/28

(57) ABSTRACT

The aim of the invention is to provide a simple winding structure on the stator of an axial flux machine and to simultaneously minimize the otherwise normal use of material by means of additional structural measures. The disc rotor- and axial flux-type rotating electric machine consists of at least of two disc-shaped rotors (1) equipped with permanent magnets. A stator (2) with axially arranged coils (4) is located between the rotors (1), and the coils (4) correspond to the permanent magnets (3) of the rotors (1). A shaft (5) is mounted on the stator (2), and the shaft (5) can additionally be mounted on stator discs (6) lying outside of the rotors (1). The rotors are secured to the shaft (5), and the stator (2) or the stator discs (6) are secured to a base or a housing (9).

A rotating electric machine of disc-rotor and axial-flux type of construction with rotors equipped with permanent magnets.

A multiplicity of disc-rotor machines and axial-flux machines are already known. The following documents are cited as the closest prior art. Document DE 10322474 A1 describes an electric machine of axial-flux type of construction, which has a stator and a rotor which are both situated opposite one another across an axial air gap. For inexpensive manufacture of the electric machine in a structural-space-saving axial-flux type of construction, which exhibits a high torque density, the stator has a pole disc with a number of flat pole segments corresponding to the desired number of poles, which flat pole segments are equidistant and are distributed in fan-shaped fashion over the disc surface and are composed of magnetically conductive material, and said stator has a ring-shaped exciter winding which is assigned, together with a return yoke, to the pole disc. Of the pole segments, the odd-numbered pole segments in the series and the even-numbered pole segments in the series are connected to one another by means of in each case one connecting piece composed of magnetically conductive material. The disc-shaped rotor is equipped, on the flat side facing toward the stator, with axially arranged permanent magnets.

Document DE 20 2012 012 653 U1 has likewise described an electrical axial-flux machine, wherein the disc-shaped stator, on both flat sides, has flat windings formed thereon. Said flat winding is distributed in encircling fashion over the flat stator. The flat winding comprises a multiplicity of flower-petal-like regions which are situated substantially radially relative to an axis of the rotor. In front of and behind the stator there is arranged in each case one disc-shaped rotor, which rotors are equipped, on the side facing the stator, with permanent magnets.

Both solutions exhibit a relatively complicated winding structure and thus involve high production costs.

It is therefore an object of the invention to provide a simple winding structure on the stator of an axial-flux machine and at the same time, by means of further design measures, to reduce the otherwise common material usage.

The advantages that can be achieved with the invention consist in particular in that the winding is of very simple construction and is technologically entirely uncomplicated. Through the omission of return yokes, the total mass of the machine is reduced. The shaft with the rotors exhibits a very low moment of inertia.

The rotating electric machine according to the invention, and advantageous embodiments of the invention, are described in claims 1 to 9.

The further development according to claim 2 describes the advantageous ratio of the number of stator coils to the number of permanent magnets of the rotors in the ratio of 3 to 4 or in a ratio of an integer multiple, wherein the number of permanent magnets is advantageously always even.

According to claim 3, the permanent magnets are incorporated into the rotors in continuous fashion, that is to say the top sides of the permanent magnets terminate with the top side of the rotor or even project slightly beyond the top sides of the rotor. Here, the permanent magnets may be incorporated into the rotors on one, two or more circular paths, wherein the coils of the stator are arranged so as to correspond to the one or more circular paths. In this way, the torque of the rotors is increased.

According to claim 4, the rotor is composed of a non-magnetic disc. In this way, the magnetic field is prevented from propagating as far as the shaft of the electric machine.

In the further development according to claim 5, the permanent magnets are arranged on or in the disc of the rotor. This can yield technological advantages in the processing of the permanent magnets.

According to claim 6, the rotor is magnetically insulated with respect to the shaft. This prevents the magnetic field of the electric machine from propagating as far as the shaft.

According to claim 7, a further disc and/or a ring-shaped disc composed of a magnetic material may be arranged on that side of the rotor which is averted from the stator, wherein the further disc and the ring-shaped disc are magnetically insulated with respect to the shaft. A magnetic return is made possible through the disc or the ring-shaped disc.

According to claim 8, the coils of the stator may be in the form of partial coils. This may possibly be necessary in special design solutions of the electric machine.

According to claim 9, two or more stators may be arranged with rotors situated in front of, between and behind said stators, wherein the shaft is mounted in the stators, and the rotors are fixedly connected to the shaft, and thus the number of stators is equal to n and the number of rotors is equal to n+1. It is thus possible to combine multiple stators with rotors in one machine, with the result of a torque increase in relation to an electric machine with one stator and two rotors.

Exemplary embodiments of the invention are illustrated in the drawings and will be described in more detail below. In the drawings:

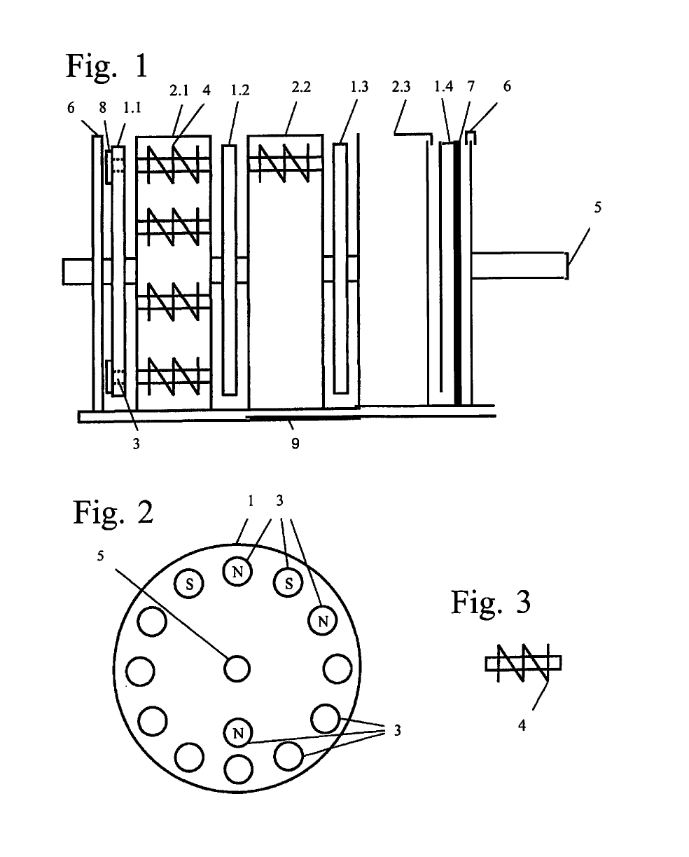

FIG. 1 shows the basic construction of the rotating electric machine in a side view,

FIG. 2 shows the side view of a rotor equipped with permanent magnets,

FIG. 3 shows the basic construction of a stator coil with a ferrite core, and

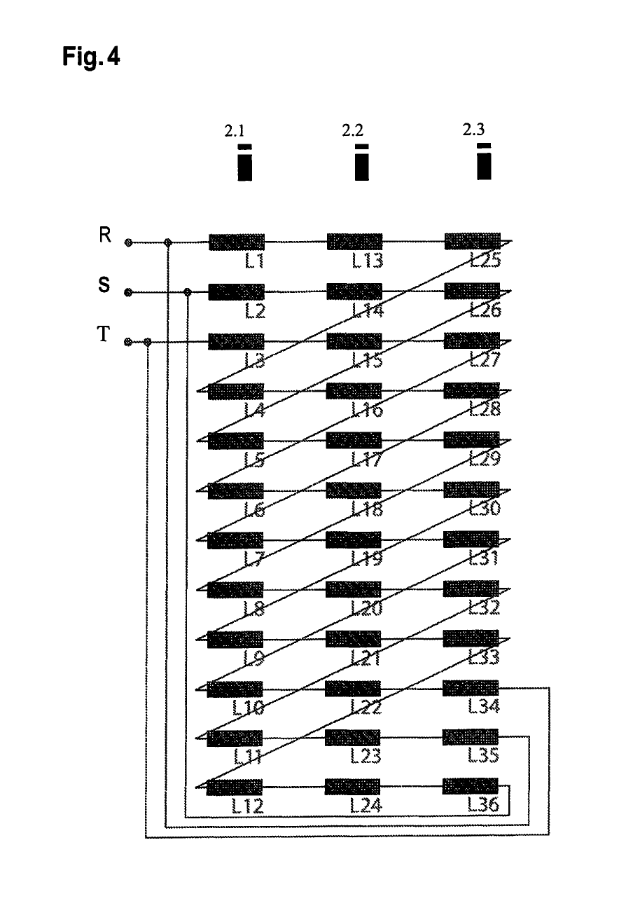

FIG. 4 diagrammatically shows a possible circuit of the stator coils of three electrically coupled-together stators.

FIG. 1 shows an electric machine according to the invention with three stators 2.1 to 2.3 and four rotors 1.1 to 1.4. The stators 2.1 to 2.3 have in each case twelve coils 4, see also FIG. 4, and the rotors 1.1 to 1.4 have in each case 16 permanent magnets 3. In this example, the permanent magnets are arranged in the rotors 1.1 to 1.4 in continuous fashion, that is to say the permanent magnets 3 terminate flush with the surface of the rotors 1.1 to 1.4. The coils 4 and the permanent magnets 3 are situated in each case on a circular path in the rotors 1.1 to 1.4 and in the stators 2.1 to 2.3 respectively, and correspond to one another. The shaft 5 is mounted in the stators 2.1 to 2.3. It is additionally possible for the shaft 5 to be mounted in stator discs 6 situated at the outside on the right and on the left. The stators 2.1 to 2.3 are fastened to a base plate 9. The coils 4 are wound on cylindrical cores preferably composed of ferrite material. The cross section of the core and the two ends of the core may deviate from the circular shape to form known optimum shapes. The arrangement of the coils 4 with the cores parallel to the shaft 5 yields an axial magnetic field.

The magnets 3 of the rotors 1 exhibit alternating polarity. The number of permanent magnets 3 is preferably even. The permanent magnets 3 of the rotors 1.1 to 1.4 and the coils 4 of the stators 2.1 to 2.3 are arranged concordantly with one another at in each case the same angle.

The circuit configuration of the coils 4 may be similar to that in typical brushless direct-current machines. An example is illustrated in FIG. 4. The terminals R, S and T are situated at the inputs of the coils L1, L2 and L3 of the first stator 2.1. The outputs thereof are connected in each case in series with the identically positioned coils L13, L14 and L15 of the second stator 2.2. The outputs thereof are connected in series with the inputs of the corresponding coils L25, L26 and L27 of the stator 2.3. The output of L25 is connected to the input of L4 etc. Thus, all coils of the R, S and T winding are connected in series. If the outputs of L34, L35 and L36 are connected to one another, a star circuit is formed. FIG. 4 shows the connections required for a delta circuit. Taking into consideration the current direction and the assignment of the coils 4 to the RST winding, a multiplicity of different parallel and series circuits, with correspondingly different internal resistances, is possible.

A torque is generated on the rotor 1.1 by the corresponding current of the stator 2.1. By means of the present arrangement of the permanent magnets 3 of the rotor 1.2, said rotor provides for the magnetic return. Conversely, a torque is likewise generated in the rotor 1.2 by the stator 2.1, wherein, for this purpose, the rotor 1.1 provides for the magnetic return. This process is repeated for the rotor 1.2, the stator 2.2 and the rotor 1.3 and, as viewed further to the right in FIG. 1, for the rotor 1.3, the stator 2.3 and the rotor 1.4.

In order to increase the torques, the permanent magnets 3 may be incorporated into the rotors 1 on one, two or more circular paths, and the coils 4 may be arranged analogously in the stators 2. The magnets 3 of the individual circular paths correspond to the coils 4 of the corresponding circular paths.

The number of coils 4 of the stator 2 is preferably, in relation to the number of permanent magnets 3 on the rotor 1, in a ratio of three coils 4 to four permanent magnets 3 or an integer multiple thereof, for example in a ratio of 9:12 or 12:16. Other ratios are conceivable.

A further disc 7 and/or a ring-shaped disc 8 composed of a magnetic material may be arranged on that side of the disc 1 which is averted from the stator 2. A strong magnetic return is realized by means of the disc 7 or ring-shaped disc 8. The disc 7 and the ring-shaped disc 8 are magnetically insulated with respect to the shaft 5.

The coil 4 can be wound very easily onto the coil core. The connection of the coils 4 to one another likewise does not pose any problems. In desired detail design solutions, the coils 4 may also be composed of partial coils.

### LIST OF REFERENCE DESIGNATIONS

1—Rotor, disc
1.1—Rotor 1 of a machine
1.2—Rotor 2 of a machine
1.3—Rotor 3 of a machine
1.4—Rotor 4 of a machine
2—Stator
2.1—Stator 1 of a machine
2.2—Stator 2 of a machine
2.3—Stator 3 of a machine
3—Permanent magnet
4—Coil
5—Shaft
6—Stator disc
7—Disc
8—Ring-shaped disc
9—Base plate, housing

1. A rotating electric machine of disc-rotor and axial-flux type of construction, characterized in that, between at least two disc-shaped rotors (1) equipped with permanent magnets, there are provided a stator (2) with coils (4) arranged axially between the permanent magnets (3) of the rotors (1) and corresponding to the permanent magnets (3), and in that the stator (2) has, centrally, a shaft (5) which is mounted on the stator (2), and/or in that the shaft (5) is mounted on stator discs (6) situated outside the rotors (1), and the rotors (1) are fastened to the shaft (5), and the stator (2) or stators (2) and the stator discs (6) are fastened to a base plate (9) or housing (9).

2. The rotating electric machine as claimed in claim 1, characterized in that the number of coils (4) of the stator (2) and the number of permanent magnets (3) on the rotor (1) are preferably arranged in a ratio of three coils (4) to four permanent magnets (3) or an integer multiple thereof.

3. The rotating electric machine as claimed in claim 1, characterized in that the permanent magnets (3) are incorporated into the rotors (1) in continuous fashion on one, two or more circular paths, and the coils (4) are arranged so as to correspond with the one or more circular paths.

4. The rotating electric machine as claimed in claim 1, characterized in that the rotor (1) is composed of a non-magnetic disc (1).

5. The rotating electric machine as claimed in claim 1, characterized in that the permanent magnets (3) are arranged on or in the disc (1).

6. The rotating electric machine as claimed in claim 1, characterized in that the rotor (1) is magnetically insulated with respect to the shaft (5).

7. The rotating electric machine as claimed in claim 1, characterized in that a further disc (7) and/or a ring-shaped disc (8) composed of a magnetic material is arranged on that side of the disc (1) which is averted from the stator (2), and in that the further disc (7) and the ring-shaped disc (8) are magnetically insulated with respect to the shaft (5).

8. The rotating electric machine as claimed in claim 1, characterized in that the coil (4) is formed from partial coils.

9. The rotating electric machine as claimed in claim 1, characterized in that two or more stators (2) are arranged with rotors (1) situated in front of, between and behind said stators, wherein the shaft (5) is mounted in the stators (2), and the rotors (1) are fixedly connected to the shaft (5), and thus the number of stators (2) is equal to n and the number of rotors (1) is equal to n+1.
